(19) United States
(12) Patent Application Publication
(10) Pub. No.: US 2009/0293811 A1
(43) Pub. Date: Dec. 3, 2009

(54) Bale-buddy animal feeder with powered hinged floor

(76) Inventor: Gerard G. Wersal, Prior Lake, MN (US)

Correspondence Address: Gerard George Wersal, 6351 170th Street E., Prior Lake, MN, 55372, US

(21) Appl. No.: 12/386,946

(22) Filed: Apr. 24, 2009

Related U.S. Application Data
(60) Provisional application No. 61/125,724, filed on Apr. 28, 2008.

(51) Int. Cl. A01K 1/10; A01K 5/00

(52) U.S. Cl. 119/57.92; 119/58

(57) ABSTRACT

The Bale-Buddy is an animal feeder with removable adjustable legs, a movable hinged floor powered by suspension or compression springs, weights, elastic bands or other power source variations thereof, a rearward and upward slanted grill and a trough that catches small bits preventing loss of feed on the ground and constructed in various lengths to accommodate group or solo feeding. The powered hinged floor can be fixed in its lowered position for bulk filling the feeder from the rear as well as from the top. When released from its lowered filling position the powered hinged floor raises feed upward and forward to the back slanted grill as feed at the grill is consumed. By raising the feed upward and forward, every bit is reachable by the animal(s) leaving no amount of feed to decay. The feeder can be constructed in various lengths thereby accommodating the simultaneous feeding of multiple animals. To accommodate a different type of animal like sheep, llamas, deer, alpacas, horses, etc. one merely changes the grill to one with different spacing between the vertical grill bars. The elevation of the feeder is changed by setting it on the ground or by adjustable legs thereby accommodating the various sizes of animals. The Bale-Buddy is an improved feeder that saves money, feed and labor.

### CROSS-REFERENCE TO RELATED APPLICATION

This non-provisional application cross-references to application No. 61/125,724 filed Apr. 28, 2008 as a provisional patent application for this invention. This non-provisional application claims the benefits of the provisional application but revises the title and makes minor changes to the language and preferred embodiment of the invention.

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER LISTING COMPACT DISC APPENDIX

“Not Applicable”

### BACKGROUND OF THE INVENTION

In the field of animal husbandry, feed cost, waste and labor associated with both are a continual challenge to the operator. Additional concerns include animal health and behavior around a feeder. FIGS. 1-6 (page 16) represent prior art demonstrating problems and having characteristics notable to the current invention.

Some prior art feeders like that in FIG. 1 are filled from the top and gravity brings feed to the bars or grill as the supply is consumed. To keep the animal from feeding from the top and wasting feed, the top of the feeder must be positioned above the normal reach of the animal. Two significant problems exist with this feeding method. First is the configuration of the grill, which slants upwardly and toward the animal like the shape of a “V”. The animal must eat through the grill with its neck contorted and its face below the feed resulting in an unnatural uncomfortable feeding stance and resulting in a frequency of irritation and infections due to feed, dust and chaff dropping into the eyes, ears and nostrils. The second problem is the difficulty of hoisting the feed up to the top of the feeder to fill it. See FIGS. 1 & 2.

The feeder in FIG. 2 attempts to solve the second problem utilizing a pivotally mounted basket shaped like a “V”, which can be filled from the top or from the side by tipping the basket. The benefit being, one does not have to lift the feed as high to fill the feeder. This does not address the first problem of feed, dust and chaff dropping into the eyes, ears and nostrils of the animal as it feeds. The unnatural feeding stance remains a problem with this feeder also. Animals will try to grab a clump of feed and drop it on the ground to eat, which is more comfortable for them. Now we have the problem of trampling, ground contamination and waste.

Prior art as depicted in FIG. 3 solves the first problem of feed, dust and chaff falling in the eyes, ears and nostrils of the animal. This is done by slanting the grill upward and away from the animal. However, this embodiment has other inherent limitations. First, it can only be filled from the rear using relatively small sized portions instead of filling in bulk or with whole bales. Second, it is designed for use as a solo feeder. Third, feed at the bottom rear of the feeder will be difficult or impossible for the animal to reach. This will require frequent cleaning lest there be feed left to decay and waste.

FIG. 4 shows another common embodiment of a feeder, which must be filled from the top. In this embodiment, the animal puts its head through the bars to grab the feed. While this feeder can serve a plurality of animals, many animals are not comfortable eating within the confines of such a mechanism. As a result, they will grab a large amount of feed, pull it through or over the bars and eat from the ground. In this embodiment there is significant loss of feed due to trampling and ground contamination.

FIG. 5 and FIG. 6 show other prior art feeders with significant similarities. The differences between these patents are irrelevant with regard to the current invention but their similarities deserve mention. Both utilize a grill comprised of bars thereby limiting the amount the animal can take from the feeder with one bite. Both use spring power as the preferred method to bring feed to the grill to be consumed. Both have holes or slats at the bottom to allow dust, sand and other contaminants to fall through the bottom of the feeder. Both feeders are filled by lifting the top grill, thus opening the feed chamber and inserting a flake, chip or fork full of feed. In their preferred embodiments, both feeders seem to be limited for to use by a single animal and not by a plurality of animals. By design, these feeders must have an empty space or chamber below the feed floor, which is equal to or greater than the capacity of the feed chamber. It is unlikely that this would be a suitable feeder for smaller animals such as sheep because of the minimal feed capacity of a low profile feeder of this embodiment. While the feeder in FIG. 5 has a trough on the side to feed grain, neither feeder has a trough at the grill to catch the feed fragments, which might fall as the animal pulls feed through the grill. As such, feed will be lost on the ground due to trampling and contamination just as in previous examples. The bottom holes render these feeders unsuitable for feeding small cubes, pellets and grain.

### Field of Search and References

| | |
|---|---|
| Int. Cl. | A01K 1/10, A01K 5/01, A01K 5/02 |
| U.S. Cl. | 119/58, 119/60, 119/61 |
| Field of Search | 119/58, 59, 60, 61, 62, 63, 65, 68, 69, 103, D30/13, 131 |

### U.S. Patent Documents

| | | | |
|---|---|---|---|
| 5,000,122 | May 1992 | Smith | 119/58 |
| 4,020,794 | May 1977 | Nethery | 119/58 |
| 4,976,222 | December 1990 | Cooke | 119/60 |
| Des. 264, 138 | April 1982 | Harden | D30/13 |
| 4,488,510 | December 1984 | Lundgren, Sr. | 119/60 |
| 4,285,300 | August 1981 | Spane | 119/58 |
| 4,574,740 | March 1986 | Koebel | 119/60 |
| 4,580,528 | April 1986 | Kendal | 119/53 |
| 4,722,302 | February 1988 | Gee, Jr. | 119/60 |
| 4,930,449 | June 1990 | Harton | 119/60 |
| 5,189,985 | May 1993 | Brady | 119/60 |
| 5,375,559 | December 1994 | Baadsgaarg | 119/58 |
| 5,595,140 | January 1997 | Charboneau | 119/58 |
| Des. 392,777 | March 1998 | Scribner | 30/131 |
| 195,351 | August 1877 | Crabb | |
| 6,431,117 B1 | August 2002 | Rauch | 119/58 |

### Foreign Patent Documents

| | | | |
|---|---|---|---|
| PCT/CA90/00162 CA | May 1990 | Akins | A01K 1/10 |
| PCT/CA96/00043 US | January 1996 | Kleinsasser | A01K 5/02 |
| PCT/CA1998/000675 | July 1998 | Kleinsasser | A01K 5/02 |
| PCT/CA2005/00128 | February 2005 | Kleinsasser | A01K 5/01, A01K 5/00 |
| PCT/AU2006/000787 | June 2006 | Aisthorpe | A01K 5/01, A01K 1/10, A01K 39/014 |
| PCT/US2006/039363 | October 2006 | Rausch | A01K 5/01 |
| PCT/AU2007/001040 | July 2007 | Kenna | A01K 5/00, A01D 90/10, A01D 90/12 |

### BRIEF SUMMARY OF THE INVENTION

The Bale-Buddy¹, which is the subject of this invention, is an improved feeder that is easier to load, eliminates nearly all waste and results in much less labor for feeding and for disposal of waste. As such, it saves on labor, feed and money. It is a feeder that minimizes if not eliminates the chance of dust and chaff falling into the face and eyes of the animals and it's a comfortable feeder from which to graze.

The Bale-buddy is a group or solo feeder for various sizes and numbers of animals. The powered hinged floor⁶ is quick latched in the down position for easy filling of the feeder. Feed needs only be lifted waste high as opposed to most other feeders which require lifting feed over the top of the feeder to fill them. When the quick latch⁷ is released the hinged floor raises up and forward as animals graze, using power provided by springs⁵ or other means, thus bringing the feed to the grill² so all the feed is accessible to the animal(s) thereby eliminating any loss of feed due to waste or decay in unreachable corners. The grill² (feeding surface), comprised of vertical and horizontal bars, slants upward and away from the animal(s) so feed, dust and chaff will not fall into the eyes, ears and nose of the grazing animal(s) because they eat from above the feed. Because they can comfortably take feed through the grill animals will be unlikely to grab clumps to unload the feeder and eat from the ground. The trough³ with sub floor⁸ collects any feed bits dropped while feed is pulled through the grill², thereby minimizing any loss due to trampling or other aspects of ground contamination. The sub floor⁸ can be easily removed for cleaning by sliding it out from the rear. The feeder is easily filled in bulk or full bales from the rear or the top. Removable adjustable legs⁹ make it useful for short animals such as sheep as well as taller ones such as llamas or horses. The adjustable legs make the feeder exceptionally well suited for use on uneven terrain. In this embodiment, each leg is adjusted by selecting the desired hole on the leg⁹ then inserting the pin¹⁰ and securing with a hairpin clip¹¹. The grill² is interchangeable with others having spacing of a different widths between the vertical bars making it useful for animals with narrow or wide snouts. The feeder can be fitted with adjustable legs having anchors¹⁴ to prevent rowdy animals from inadvertently moving or tipping the feeder. The extensions can also be fitted with wheels¹⁵ to make relocation easy enough to be accomplished by one person. While it's uncommon, in applications where strong winds are prevalent, a screen can be fitted across the rear of the feeder to prevent loose feed from being blown out of the feeder.

### BRIEF DESCRIPTION OF THE DRAWINGS

FIGS. 1-6 represent prior art and are used for comparison to help explain improvements provided by the current invention. FIGS. 7-14 are views of a preferred embodiment of the current invention and these drawings, depictions and comments are for demonstration and descriptive purposes only. None are intended to represent a limiting factor in terms of size, shape, material, assembly, adjustment or any other characteristics.

FIG. 1 Prior art is included for explanation purposes.

FIG. 2 Prior art U.S. Pat. No. 5,000,122 is included for explanation purposes.

FIG. 3 Prior art U.S. Pat. No. 4,976,222 is included for explanation purposes.

FIG. 4. Prior art Des. 264,138 is included for explanation purposes.

FIG. 5 Prior art U.S. Pat. No. 195,351 is included for explanation purposes.

FIG. 6 Prior art U.S. Pat. No. 6,431,117 B1 is included for explanation purposes.

FIG. 7 is a 3D view of a preferred embodiment of the invention with removable adjustable leg extensions⁹ installed.

FIG. 8 shows the interchangeable grill² pulled out for depiction.

FIG. 9 is a 3D view of a preferred embodiment of the invention with the steel sheath removed from the nearest side frame¹² showing grill², trough³, pivot point⁴, hinged floor⁶, suspension springs⁵, rear brace¹³, leg assembly braces¹⁷ and some assembly bolts¹⁶.

FIG. 10 is a side view of the feeder with nearest end panel removed showing beveled latch⁷ for holding the hinged floor⁶ down with suspension springs⁵ extended for easy filling.

FIG. 11 is a side view showing one of the stubs¹⁸ which holds a shoulder bolt making one of the pivot points of the hinged floor and showing the hinged floor⁶ unlatched (floating) so it can rise as animals graze and feed is consumed.

FIG. 12 is the hinged floor⁶ pulled out showing where shoulder bolts will insert to create the pivot points⁴.

FIG. 13 is a cross-section showing hinged floor⁶, removable sub-floor⁸ and leg brace¹⁷ adjustable/removable leg extensions⁹ (1 of 4) with pin¹⁰ and hairpin clip¹¹ and leg extension with anchor stake¹⁴ and wheel¹⁵ accessories.

FIG. 14 shows a cross-section depicting sub-floor⁸ as it is removed.

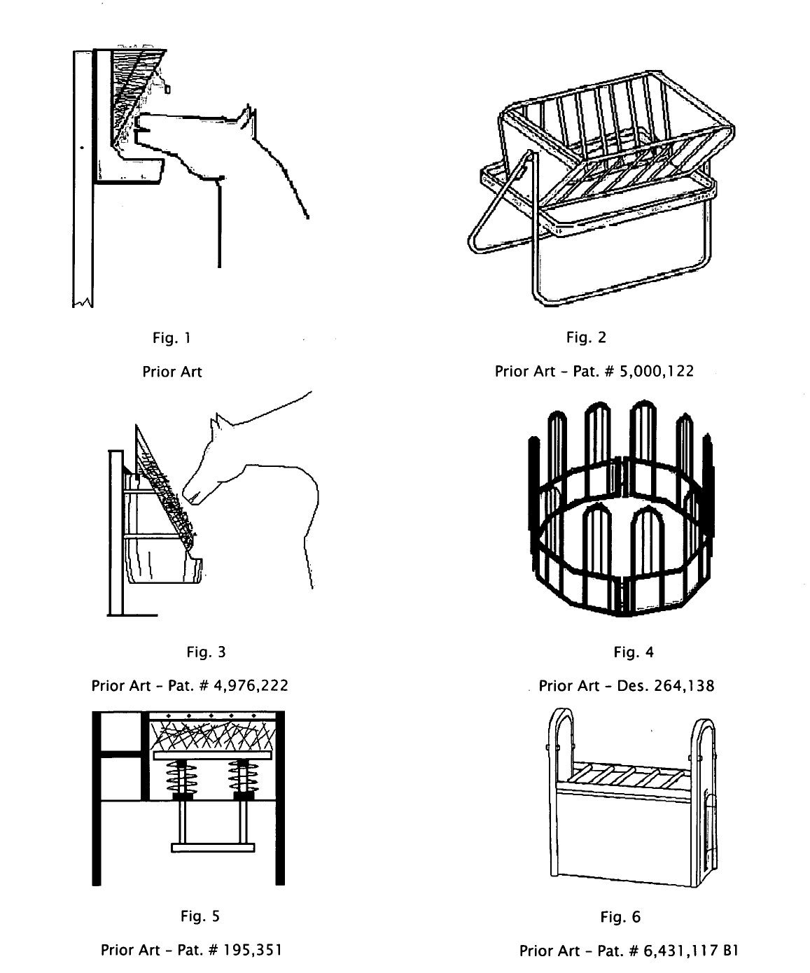

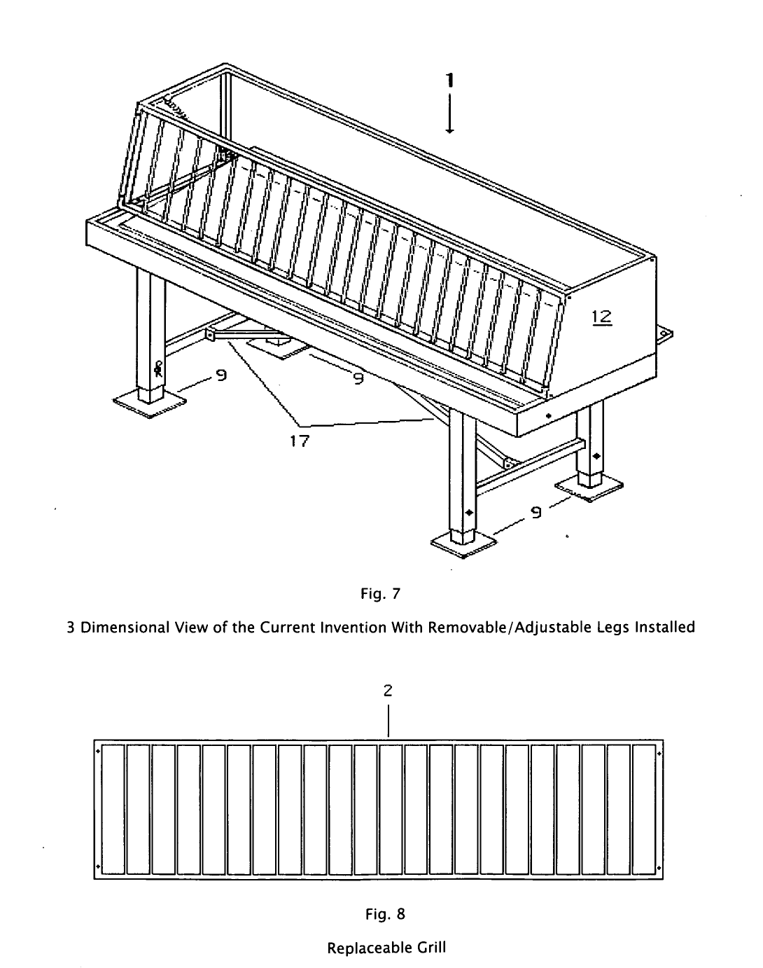

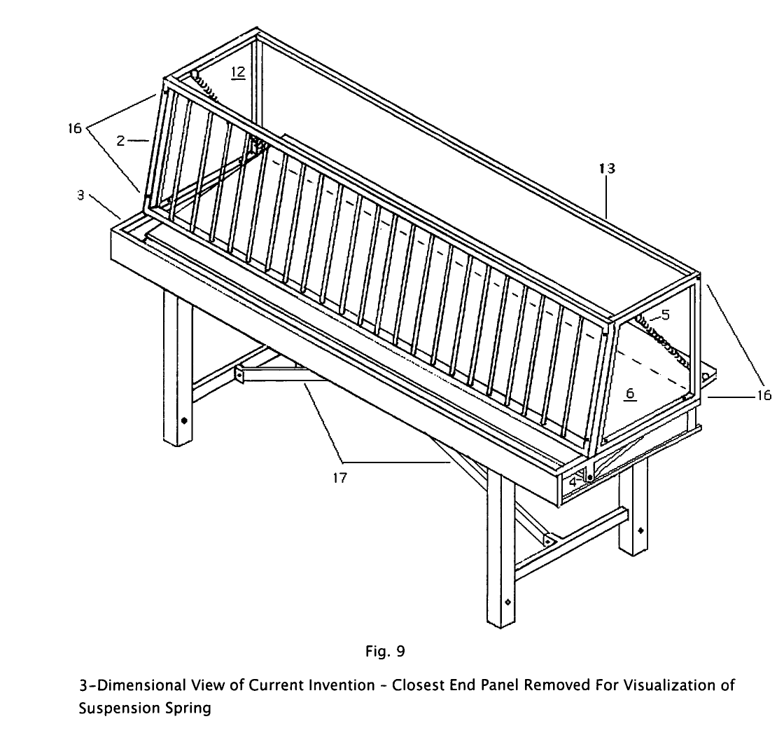

### DETAILED DESCRIPTION OF THE INVENTION

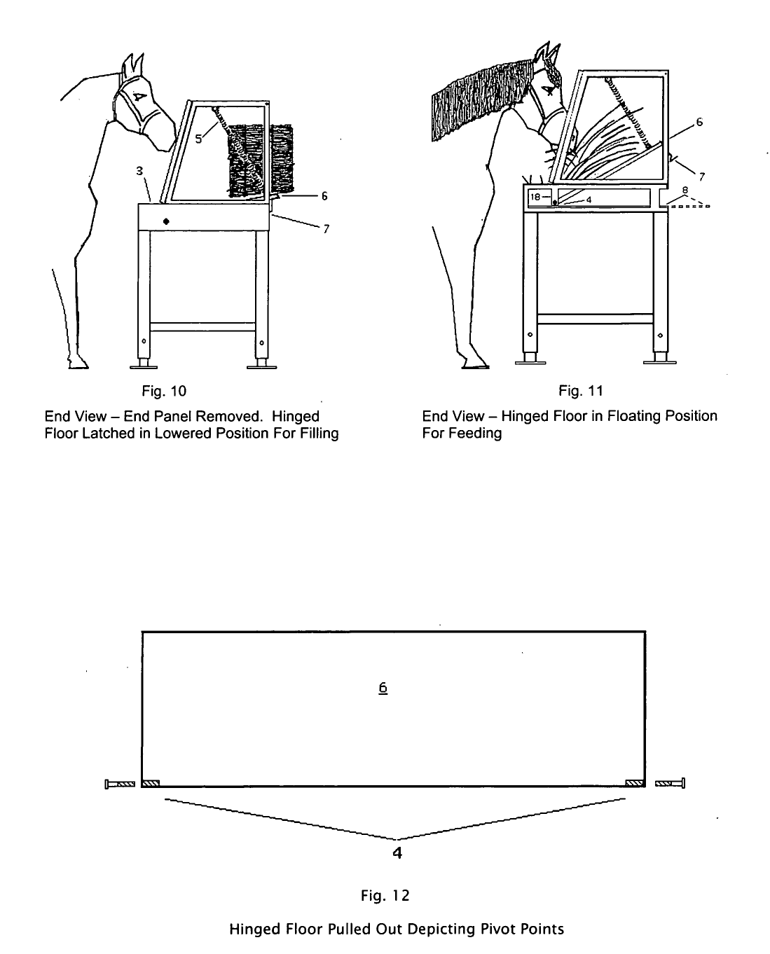

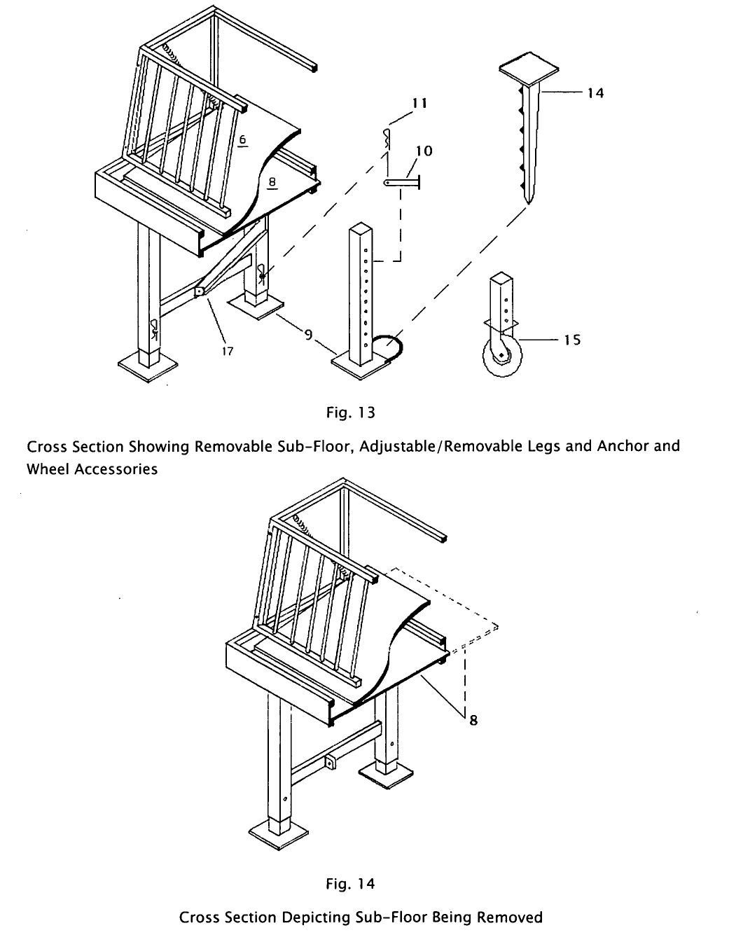

The Bale-Buddy animal feeder with powered hinged floor and back slanted grill that is the subject of this invention is shown in FIGS. 7-14 and addresses all the aforementioned problems and limitations while adding features, which enhance the versatility of the invention. The measurements and material compositions in this description are intended for descriptive purposes only. They are not intended to represent a limitation of any type. The Bale-Buddy is essentially comprised of a trough, a grill assembly, hinged floor assembly and adjustable leg assembly.

The trough of the Bale-Buddy in its preferred embodiment is constructed of a square tubular steel frame sheathed with sheet steel on the front and sides. Tubular steel is more durable than other options like wood, composites, aluminum etc. In the case of larger animals and animals prone to cribbing durability is a concern. The frame of the trough is 8 feet long, 44 inches wide and 6 inches deep. On the bottom of the frame two support braces are installed from front to rear at 32 inches from each side. They provide support for the mid-section of the sub floor as well as connecting points for the diagonal braces of the leg assemblies.

On each side of the feeder, 10 inches from the front, on the top bar of the frame, a stub of square tube is fitted which extends down toward the bottom bar of the frame. The length of the stub is such that it stops ¾ inch from the bottom of the sub floor. Holes are drilled laterally through the bottom of each stub to accommodate the shoulder bolts that will be the pivot points of the powered hinged floor. The holes will be oversized to accommodate bushings made of bronze, brass, ceramic, nylon or other types of durable non-oxidizing material. The bushings will insure smooth easy action when the hinged floor operates. The rear is left open to accommodate the sub-floor sliding out the rear for cleaning. The sub floor is a treated sheet of plywood 95 in.×44 in.×½ in.

The hinged floor is 93 inches long and 36 inches wide. The frame of the hinged floor is constructed of square steel tubing and the top is fitted with a sheet of galvanized steel fastened to the frame with self-tapping screws. The galvanized steel will not oxidize and it provides a smooth surface for feed to slide down and forward as it pulled by grazing animals. The extreme forward sides of the tubular square frame will be drilled and tapped so that they will receive the shoulder bolts, which are inserted through the bushings from each side of the trough frame. When the shoulder bolts are installed, the hinged floor will pivot at the front through the bushings when lift power is applied by the springs attached to the rear of the hinged floor.

The width of the hinged floor is 36 inches and when installed and lowered it will extend past the rear of the trough frame by 2 inches. Thus, even when it's in the lowered (open) position the hinged floor will have a forward slope. As animals graze from the feeder the slope will direct feed down and forward to the grill. The slope will also insure that feed does not set in water in the case of rain or melting snow.

The two rear corners of the hinged floor will be fitted with eyebolts. These will be the attachment points for the springs, which will supply power for lifting the hinged floor. The rear center of the hinged floor will be fitted with a beveled latch⁷. Gravity will cause the beveled latch to set automatically when the hinged floor is pushed to its maximum down (open) position. This will allow a wide-open rear area to accommodate filling the feeder with full bales and ultimately a greater feed capacity. When filled the operator can, with minimal effort, release the beveled latch thereby allowing the rear of the hinged floor to be lifted and thus positioning feed at the back slanted grill.

The upper portion of the Bale-Buddy is comprised of a grill, sides and a brace connecting the top rear of each side. Each of the two sides is constructed with square tubular steel sheathed with sheet metal. In the present embodiment, the bottom of each side is 34 inches long, the rear is 32 inches high, the top is 19 inches long and the front is 35⅜ inches long. When assembled, the slant of the fronts will be upward and rearward. When the grill is attached to the sides, it will have a back-slant of 76 degrees. This will allow animals to graze from above the feed through the grill.

On the inside top front of each side, holes will be drilled and eyebolts will be fitted into them. These eyebolts will be the attachment points for the springs whose opposite ends attach to the eyebolts on the rear of the hinged floor. The front of the side frames will be drilled on top and bottom horizontally from front to rear to receive the bolts that will mount the grill to the side frames.

Vertical holes will be drilled in the front and rear of the bottom of the side frames. They will mate with corresponding holes drilled vertically in the upper frame of the trough. Two bolts will fix each of the sides of the grill to the trough.

Holes will be drilled horizontally in the top rear of the grill sides. Bolts will pass through these two holes and screw into each end of the brace between upper rear grill side frames. The brace will be a length of square tubular steel 94 inches long having threaded ends to receive the bolts.

The grill itself is 8 feet long by 35⅜ inches high. It is constructed of horizontal and vertical tubular steel bars. The number of vertical bars and spacing between them is dependent on the snout size of the animal for which the feeder is being used. Narrow snouts like sheep or llamas would require more bars with less space between them when compared to draft horses requiring fewer bars and greater space between them. Holes will be drilled in the grill corners from front to back. The 4 bolts that mount the grill to the side frame will pass through these holes and the matching holes of the front of the side frames. Only these 4 bolts need to be removed to interchange the grill with another to accommodate animals of a different size.

The grill assembly is fitted on the top frame of the trough 10 inches back from the front of the trough. This effectively provides a trough 8 feet long, 10 inches wide and 6 inches deep from which animals can eat the food bits which have dropped as a result of pulling feed through the feeder. The amount of feed falling on the ground is little to none. As a result, waste is practically eliminated.

For animals short in stature, the Bale-Buddy can set on the ground. Or, it can be fitted with an adjustable leg assembly. The adjustable leg assembly is constructed of square tubular steel. Each half of the assembly is comprised of two legs attached by a horizontal brace between the legs about 6 inches from the bottom. Holes drilled in the tops of each leg will accommodate the bolts that attach the leg assemblies to the bottom frame of the trough drilled with corresponding holes. Holes will be drilled horizontally about 3 inches from the bottom of the legs to accommodate the adjustable leg extensions. 1 in.×1 in.×¼ in. flat irons having holes drilled in their centers will be welded one inch apart and centered on the horizontal leg braces. The same will be welded on each of the two inward braces on the bottom of the trough. A square tubular steel bar with holes drilled in each end will attach diagonally from the leg braces to the bottom trough braces with bolts. This will make the legs rigid and prevent collapse of the feeder.

The leg extensions are constructed of square perforated tubular steel. 4 in.×4 in.×¼ in. steel plates are welded to one end of the extensions and these will set on the ground. The other end will slide up into the fixed leg assemblies whereby insertion of a pin through the hole in the fixed leg and a chosen hole of the perforated leg extension will allow adjustment of the legs to determine proper height for the particular animals being fed. The pins are secured with hairpin clips. The leg extensions are adjusted individually to insure stability on uneven ground.

Sometimes large animals will get pushy around a feeder and possibly tip a feeder over. To prevent this potentially dangerous situation, the bottom plates of the leg extensions can be fitted with steel loops. Stakes with heads can be passed through the loops and driven into the ground. Then, even with significant rowdiness animals will be unlikely to tip the feeder over.

For applications where the feeder needs to be moved frequently, the leg extensions can be fitted with swivel casters.

An improved animal feeder with a powered hinged floor and back slanted grill that can be bulk filled easily from the rear or the top, can be used for groups of animals or solo feeding, minimizes waste, and provides healthier more natural feeding methods thereby saving money, feed and labor.

1. Claim 1 being a feeder¹ comprised of a trough³ and a feeding grill² that slants up and away from the feeding animal(s) and of variable lengths suitable for feeding a plurality of animals simultaneously.

2. Claim 1 being constructed such that said feeding grill² can be easily replaced with one having larger or smaller spaces between the upright bars in order to accommodate animals having larger or smaller snout or muzzle sizes.

3. Claim 2 also having a powered hinged floor having pivot points⁴ at the front of the hinged floor⁶ and suspension springs⁵ or another power source for raising the rear of the hinged floor up and forward toward the feeding grill².

4. Claim 3 also having a latch⁷ at the rear of said hinged floor for securing the hinged floor⁶ in the down position for easy filling and released for feeding.

5. Claim 1 able to be fitted with removable adjustable leg⁹ extensions wheels or anchor posts.
